(19) United States
(12) Patent Application Publication
(10) Pub. No.: US 2020/0112668 A1
(43) Pub. Date: Apr. 9, 2020

(54) METHOD AND APPARATUS FOR CAMERA ACTIVATION

(71) Applicant: MOTOROLA SOLUTIONS, INC, Chicago, IL (US)

(72) Inventors: TAL GILOR, CARCUR (IL); GABI OFIR, RESHON LETZION (IL); ALEX RIVKIN, MEVASERET ZION (IL); YOTAM KESHET, TEL AVIV (IL)

(21) Appl. No.: 16/150,398

(22) Filed: Oct. 3, 2018

(51) Int. Cl. H04N 5/232; H04W 4/80

(52) U.S. Cl. CPC H04N 5/23206; H04N 5/232933; H04W 4/80

(57) ABSTRACT

A method and apparatus for activating a camera is provided herein. During operation a first camera will be activated (set to record). The first camera may be activated by a manual activation, or activated by reception of a particular network identification (ID) being received. The trigger that causes the first camera to activate will also cause the first camera to begin transmitting the network to trigger other cameras to record.

### BACKGROUND OF THE INVENTION

Continuous recording on wearable cameras used by public safety officers introduces challenges. One challenge facing the cameras is battery life. For example, there may not be enough battery life for an officer to keep a wearable camera in operation on a permanent basis. Another challenge is the amount of data acquired by a continuously-operating camera. Analyzing and storing terabytes of video footage consumes lots of time and resources (human and/or computing). Therefore, manual activation of wearable cameras is preferred; however, manual activation of camera is not always possible in the moments that matter, because saving the life of citizen and/or officer is more important than turning on the camera. Therefore, a need exists for a method and apparatus for automatically activating a camera when needed.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram of a camera.

FIG. 2 is a flow chart showing operation of the camera of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above, mentioned need, a method and apparatus for activating a camera is provided herein. During operation a first camera will be activated (set to record). The first camera may be activated by a manual activation, or activated by reception of a particular network identification (ID) being received, or by any other trigger (e.g., from a sensor such as a gun-draw sensor). The trigger that causes the first camera to activate will also cause the first camera to begin transmitting (i.e., broadcast simultaneously to several cameras) the network ID to trigger other cameras to record.

In a preferred embodiment of the present invention, the network ID comprises a network name and/or a device name. For example, the network ID may comprise a name of a network that uses radio waves to provide wireless high-speed Internet and network connections. In one embodiment of the present invention, the network ID comprises an IEEE 802.11x Server Set ID (SSID) transmitted via radio waves. In another embodiment of the present invention, the network ID comprises a Bluetooth “user friendly” name, or a Network Service Discovery (NDS).

Although the text below will use the term “network ID”, one of ordinary skill in the art will recognize that any “network name”, “access point name”, or any other network Identifying information may be used. Thus, the term “network ID” is meant to encompass things such as, but not limited to an access point name, an SSID, a Bluetooth device name, . . . , etc.

As discussed above, cameras that receive the network ID will begin recording video and/or audio and also begin transmitting the network ID to trigger activation of other cameras. It should be noted that only particular network IDs will trigger activation of a camera and re-propagation of the network ID. More particularly, a particular camera will match captured network ID against known network IDs (S1, S2, . . . , Sn), and if a match exists a camera is activated. If camera B sends network ID Sx that is received by camera A, camera A will check if the known network IDs set include Sx; if not, camera is not activated. If Sx is known at camera A, camera A will begin recording, and also begin transmitting Sx as a network ID (e.g., an 802.11 SSID).

It should be noted that the network ID does not need to be transmitted by a camera. As an example of the above, police radios (mobile radios) may have a list of network IDs which will activate local cameras. Radios that receive the network ID may again forward the network ID to other radios. Therefore, if a camera receives a known network ID from any source, the camera may be activated as described above.

In one embodiment of the present invention, once a camera is activated via the reception of a network ID, the camera can be inactivated manually by receiving a “stop recording” command, for example, by pushing a “stop recording” “button”. Once the camera is inactivated, it will stop transmitting the network ID.

It should also be noted that once a camera is activated by the reception of a particular network ID, the camera may be inactivated when the particular network ID is no longer received, or alternatively, when inactivated manually by a user.

Finally, although cameras are configured to transmit a network ID, the cameras may, or may not provide network services. In other words, cameras need not be configured to provide wireless high-speed Internet and network connections. Thus, cameras may be configured to provided and transmit network IDs, but may not have the necessary hardware/software to provide wireless high-speed Internet and network connections.

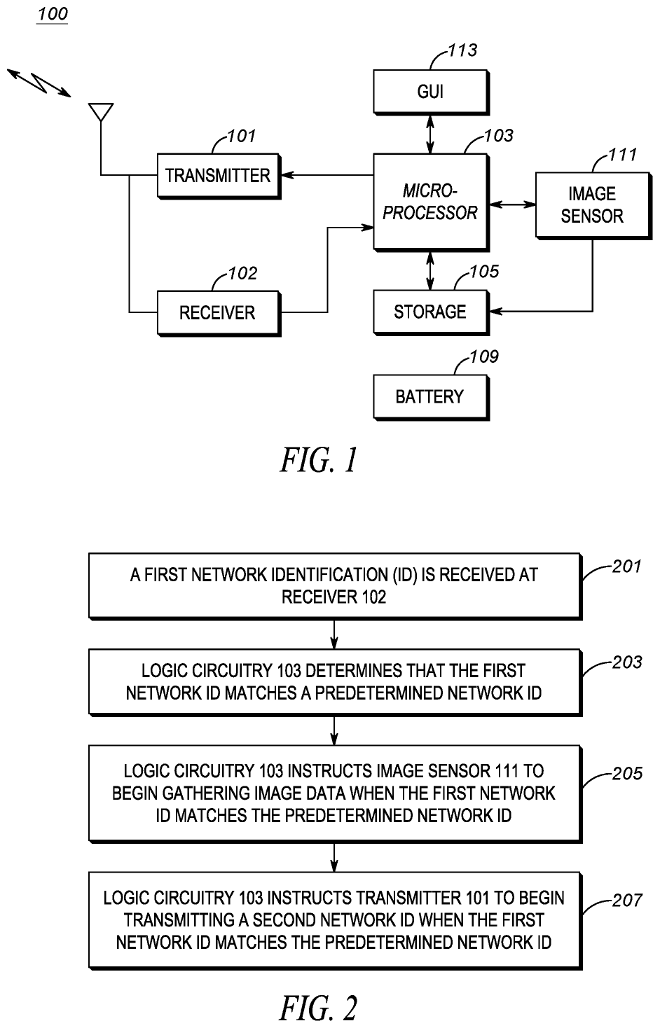

FIG. 1 is a block diagram of camera 100. Camera 100 comprises processor 103 that is communicatively coupled with various system components, including transmitter 101, receiver 102, general storage component 105, battery 109, Graphical-User Interface (GUI) 113, and an image or video sensor 111. Only a limited number of system elements are shown for ease of illustration; but additional such elements may be included in the camera 100.

Battery 109 provides power to device 101 when not hard connected to an external power source.

Processing device 103 (logic circuitry) may be partially implemented in hardware and, thereby, programmed with software or firmware logic or code for performing functionality described herein; and/or the processing device 103 may be completely implemented in hardware, for example, as a state machine or ASIC (application specific integrated circuit).

All storage and components can include short-term and/or long-term storage of various information needed for the functioning of the respective elements. Storage 105 may further store software or firmware for programming the processing device 103 with the logic or code needed to perform its functionality. In addition, storage 105 will store at least one network ID that, if received, will trigger activation of image sensor 111, and re-propagation of the network ID. The storage can contain data that is not explicitly the network ID (e.g., for security purposes). For example, the storage can contain keys which can lead to the explicit network ID (e.g., HashMaping).

Sensor 111 electronically captures a sequence of video frames (i.e., a sequence of one or more still images), with optional accompanying audio, in a digital format. The images or video captured by the image/video sensor 111 may be stored in the storage component 105, or may be sent directly to other devices via transmitter 101.

Transmitter 101 and receiver 102 are common radio-frequency (RF) circuitry known in the art for communication utilizing a well-known communication protocol, and serve as means for transmitting and receiving video and network IDs. For example, receiver 102 and transmitter 101 can be well known transmitters that utilize the IEEE 802.11 communication system protocol. Other possible transmitters and receivers include, but are not limited to transceivers utilizing Bluetooth, or any other communication system protocol.

GUI 113 provides a man/machine interface for receiving an input from a user and displaying information for the user. For example, GUI 113 may provide a way for a user to activate image sensor 111 (e.g., a menu, a soft button, a slider, a hard button, . . . , etc.). In order to provide the above features (and additional features), GUI 113 may comprise any combination of a touch screen, a computer screen, a keyboard, buttons, switches, or any other interface needed to receive a user input and provide information to the user.

In a preferred embodiment processor 103 receives network ID information from receiver 102 and compares any received network ID to those in storage 105. If a match occurs between any received network ID and those in storage, then logic circuitry 103 will instruct image sensor 111 to start gathering video. Logic circuitry 103 will also instruct transmitter to begin transmitting a particular network ID, the reception of which will cause other cameras to begin recording video.

It should be noted that each camera may transmit its own unique network ID. When this is the case, multiple, transmitting cameras that were activated via reception of a particular network ID, may easily be inactivated by simply having the original device that started the “cascade” to simply stop transmitting its network ID. For example, if devices are programmed to begin recording video upon receiving network IDs SS1 through SS100, and to stop recording video upon no longer hearing the triggering network ID (i.e., the network ID that caused the camera to start recording), then one camera may trigger other devices to start recording by transmitting, for example, SS23 via RF. Other devices that receive “SS23” will transmit different network IDs that may be unique to each camera. (e.g., SS1 through SS100, excluding SS23). Other cameras, upon hearing the other network IDs will begin recording and transmit their unique network IDs. This process continues.

Now consider the case where the originating camera (transmitting SS23) ceases transmitting SS23. This will cause a cascade of cameras ceasing recording functions. More particularly, those cameras that triggered upon receiving “SS23” will stop recording (and transmitting their network IDs) when “SS23” is no longer received, and the process will continue until all cameras cease recording and transmitting network IDs.

It should be noted that GUI 113 may receive a manual instruction to activate image sensor 111 and begin recording. When GUI 113 receives such an instruction and passes the instruction to logic circuitry 103, logic circuitry 103 will instruct image sensor 111 to begin acquiring image data, and will also instruct transmitter 101 to begin transmitting a particular network ID, the reception of which will cause other cameras to begin recording video.

It should be noted that GUI 113 may receive a manual instruction to stop image sensor 111 from recording. When GUI 113 receives such an instruction and passes the instruction to logic circuitry 103, logic circuitry 103 will instruct image sensor 111 to stop acquiring image data, and will also instruct transmitter 101 to stop transmitting the particular network ID.

FIG. 1 provides for 1 a camera comprising an image sensor, a radio frequency (RF) transmitter; an RF receiver configured to receive a first network identification (ID) via an over-the-air RF transmission, and logic circuitry configured to determine that the first network ID matches a predetermined network ID and also configured to instruct the image sensor to begin gathering image data when the first network ID matches the predetermined network ID.

As described above, the logic circuitry is also configured to instruct the transmitter to begin transmitting a second network ID when the first network ID matches the predetermined network ID, wherein reception of the second network ID by other cameras causes the other cameras to begin gathering image data. In one embodiment of the present invention, the first network ID has a same name as the second network ID. For example, the first and the second network may have “SS10” as the network ID.

A graphical-user interface (GUI) is provided and configured to receive a “stop recording” command from a user. As discussed, the logic circuitry is configured to instruct the image sensor to stop gathering image data when the “stop recording” command is received, and also configured to instruct the transmitter to stop transmitting the second network ID when the “stop recording” command is received.

Memory is provided, wherein the logic circuitry determines that the first network ID matches the predetermined network ID by accessing the memory and determining if the first network ID matches a network ID stored in the memory.

As described above, the logic circuitry is also configured to determine that the first network ID is no longer being received by the RF receiver and wherein the logic circuitry is configured to instruct the image sensor to stop gathering image data when the first network ID is no longer being received by the RF receiver.

FIG. 2 is a flow chart showing the operation of the camera of FIG. 1. The logic flow begins at step 201 where a first network identification (ID) is received at receiver 102 via an over-the-air RF transmission. At step 203, logic circuitry 103 determines that the first network ID matches a predetermined network ID, and instructs image sensor 111 to begin gathering image data when the first network ID matches the predetermined network ID (step 205). The logic flow continues to step 207 where logic circuitry 103 also instructs transmitter 101 to begin transmitting a second network ID when the first network ID matches the predetermined network ID. As discussed above, reception of the second network ID by cameras causes the cameras to begin gathering image data.

As discussed above, the first network ID may have a same, or differing name as the second network ID. Also, in an embodiment of the present invention, a “stop recording” command may be received from a user at GUI 113 and passed to logic circuitry 103. This will cause logic circuitry 103 to instruct the image sensor 111 to stop gathering image data, and instruct transmitter 101 to stop transmitting the second network ID when the “stop recording” command is received.

As discussed above, the step of determining that the first network ID matches the predetermined network ID comprises the steps of accessing memory/storage 105 and determining if the first network ID matches a network ID stored in the memory.

Finally, once it has been determined by logic circuitry 103 that the network ID that triggered the recording is no longer being received, logic circuitry 103 will instruct sensor 111 to stop gathering image data and instruct transmitter 101 to stop transmitting the second network ID.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A camera or structure that is “configured” in a certain way is configured in at least that way, but may also be configured in ways that are not listed.

It will be appreciated that some embodiments may be comprised of one or more generic or specialized processors (or “processing cameras”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage camera, a magnetic storage camera, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A camera comprising:
a radio frequency (RF) transmitter;
an RF receiver configured to receive a first network identification (ID) via an over-the-air RF transmission;
logic circuitry configured to determine that the first network ID was received and matches a predetermined network ID; and
an image sensor that is triggered to begin recording upon the RF receiver receiving the first network ID.

2. The camera of claim 1 wherein the logic circuitry is also configured to:
instruct the transmitter to begin transmitting a second network ID when the first network ID matches the predetermined network ID, wherein reception of the second network ID by other cameras triggers the other cameras to begin recording.

3. The camera of claim 2 wherein the first network ID has a same name as the second network ID.

4. The camera of claim 2 further comprising:
a graphical-user interface (GUI) configured to receive a “stop recording” command from a user;
wherein the logic circuitry is configured to instruct the image sensor to stop gathering image data when the “stop recording” command is received; and
wherein the logic circuitry is configured to instruct the transmitter to stop transmitting the second network ID when the “stop recording” command is received.

5. The camera of claim 1 further comprising:
memory; and
wherein the logic circuitry determines that the first network ID matches the predetermined network ID by accessing the memory and determining if the first network ID matches a network ID stored in the memory.

6. The camera of claim 1 further comprising:
a graphical-user interface (GUI) configured to receive a “stop recording” command from a user; and
wherein the logic circuitry is configured to instruct the image sensor to stop gathering image data when the “stop recording” command is received.

7. The camera of claim 1 wherein the network ID comprises a network name and/or a device name.

8. The camera of claim 1 wherein the logic circuitry is also configured to determine that the first network ID is no longer being received by the RF receiver and wherein the logic circuitry is configured to instruct the image sensor to stop gathering image data when the first network ID is no longer being received by the RF receiver.

9. A method comprising the steps of:
receiving a first network identification (ID) via an over-the-air RF transmission;
determining that the first network ID matches a predetermined network ID;
triggering a camera to record upon the reception of the first network ID.

10. The method of claim 9 further comprising the step of:
transmitting a second network ID when the first network ID matches the predetermined network ID, wherein reception of the second network ID by cameras causes the cameras to begin gathering image data.

11. The method of claim 10 wherein the first network ID has a same name as the second network ID.

12. The method of claim 10 further comprising the steps of:
receiving a “stop recording” command from a user;
stopping gathering the image data when the “stop recording” command is received; and
stopping the transmitting of the second network ID when the “stop recording” command is received.

13. The method of claim 9 further comprising:
wherein the step of determining that the first network ID matches the predetermined network ID comprises the steps of accessing a memory and determining if the first network ID matches a network ID stored in the memory.

14. The method of claim 9 further comprising the steps of:
receiving a “stop recording” command from a user; and
stopping the gathering of image data when the “stop recording” command is received.

15. The method of claim 9 wherein the network ID comprises a network name and/or a device name.
